(19) United States
(12) Patent Application Publication
(10) Pub. No.: US 2003/0209042 A1
(43) Pub. Date: Nov. 13, 2003

(54) Electronically operated lock

(76) Inventors: Tsun-Tsai Yeh, Hsinchu (TW); Tso-Tung Yu, Hsinchu (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/330,570

(22) Filed: Dec. 26, 2002

(30) Foreign Application Priority Data
May 9, 2002 (TW) 91206530

(51) Int. Cl. E05B 47/00

(52) U.S. Cl. 70/280

(57) ABSTRACT

An electronically operated lock (1) includes a two-part lock unit (2), a latch (5), and a transmission shaft (4). The lock unit includes a base (80), a top cover (20) covering the base, a driving unit (60), a handle assembly (30), and a clutch (50). The driving unit includes a gear plate (64). The gear plate includes a pair of driving protrusions (641). The handle assembly includes a controller shaft (32) fittingly receiving the transmission shaft therein, and a pinion (35). A first annular gear portion (321) is formed on a bottom of the controller shaft. The clutch includes a pair of driven protrusions (521), and a second annular gear portion (56). The driving protrusions engage the driven protrusions to rotate the clutch. The second annular gear portion meshes with the first annular gear portion via the pinion. Accordingly, the latch can be actuated between a locked state and an unlocked state.

### BACKGROUND OF THE INVENTION

1. Field of the Invention

The present invention relates to locks such as door locks, and more particularly to a lock that is electronically actuated. This application relates to a contemporaneously filed application having the title of “ELECTRICALLY DRIVEN LOCK” while with the same inventors and the same assignee with the invention.

2. Description of the Related Art

To latch a door, a bolt may be extended from the door into a suitable opening in the door jamb. The bolt may be interconnected with a bolt assembly in a conventional lock which is operated with a knob or a handle lever. The bolt is operated to extract or extend after the latch in the bolt assembly is actuated to unlocked by a key. Turning the key in the lock will either lock or unlock the latch of the bolt assembly of the lock. However, it is inconvenient for a user to have to carry the key on his or her person. In addition, the user's hands may not be free, particularly at night. Furthermore, particularly at night, it can be difficult to insert the key into the lock. Electronically driven locks can overcome these problems. However, the transmission and driving devices of conventional electronically driven locks are complicated, and require numerous components. This inflates the cost of materials and assembly. Moreover, the motor of an electronically driven lock may fail. When this happens, considerable physical effort is required to turn a key manually to operate the latch of the bolt assembly of the lock, because the transmission device and motor must be “back driven” during such operation.

### SUMMARY OF THE INVENTION

Accordingly, an object of the present invention is to provide an electronically operated lock having a simple transmission device which allows easy manufacturing and assembly, and which reduces costs.

Another object of the present invention is to provide an electronically operated lock that also allows easy manual operation of the lock.

To achieve the above objects, an electronically operated lock comprises a two-part lock unit, a bolt assembly, and a transmission shaft. The lock unit is attached to one side of a door. The bolt assembly has a latch therein, and is mounted in the door. The transmission shaft extends through a cross slot of the bolt assembly to actuate the latch between a lock status and a unlock status. The lock unit comprises a base, and a top cover covering the base. The lock unit further comprises a driving unit, a handle assembly, and a clutch therein. The driving unit comprises a gear plate. The gear plate comprises a pair of driving protrusions. The handle assembly comprises a controller shaft fittingly receiving the transmission shaft therein, and a pinion. A first annular gear portion is formed on a bottom of the controller shaft. The clutch comprises a pair of driven protrusions, and a second annular gear portion. The driving protrusions of the gear plate engage the driven protrusions of the clutch to rotate the clutch. The second annular gear portion of the clutch meshes with the first annular gear portion of the controller shaft via the pinion. Accordingly, the latch can be actuated to lock or unlock.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is an exploded isometric view of an electronically operated lock of the present invention;

FIG. 2 is an exploded isometric view of a lock unit of the lock of FIG. 1;

FIG. 3 is an enlarged view of a circled portion III of FIG. 2;

FIG. 4 is an isometric view of a base of the lock unit of FIG. 2;

FIG. 5 is an assembled view of the part of the lock unit of FIG. 2;

FIG. 6 is a top plan assembled view of part of the lock unit of FIG. 2, when the lock is in a locked position; and

FIG. 7 is similar to FIG. 6, but showing said part of the lock unit when the lock is in an unlocked position.

### DETAILED DESCRIPTION OF THE INVENTION

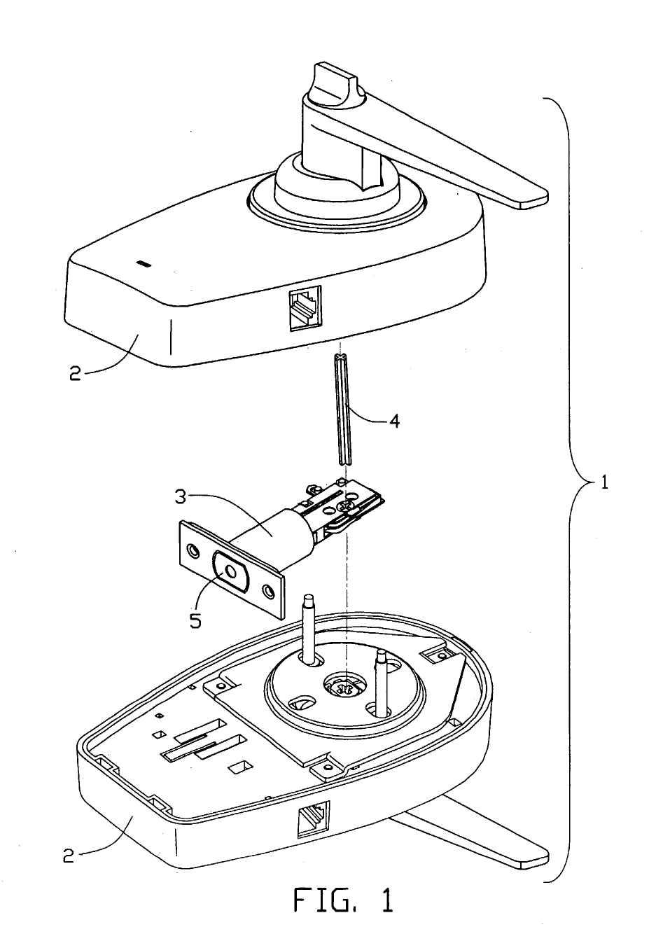

Referring to FIG. 1, an electronically operated lock 1 in accordance with a preferred embodiment of the present invention comprises a two-part lock unit 2, a bolt assembly 3, and a transmission shaft 4 having a cross-shaped cross section. The lock unit 2 is attached to one side of a door. The bolt assembly 3 has a latch (not shown) and a bolt 5 therein, and is mounted in the door. The transmission shaft 4 extends through a cross slot (not labeled) of the bolt assembly 3. The latch is actuated to unlock or lock by rotation of the transmission shaft 4. When the latch is in unlock state, the bolt 5 is operated to extend or retract. Accordingly, the door to which the lock 1 is attached can be latched or unlatched.

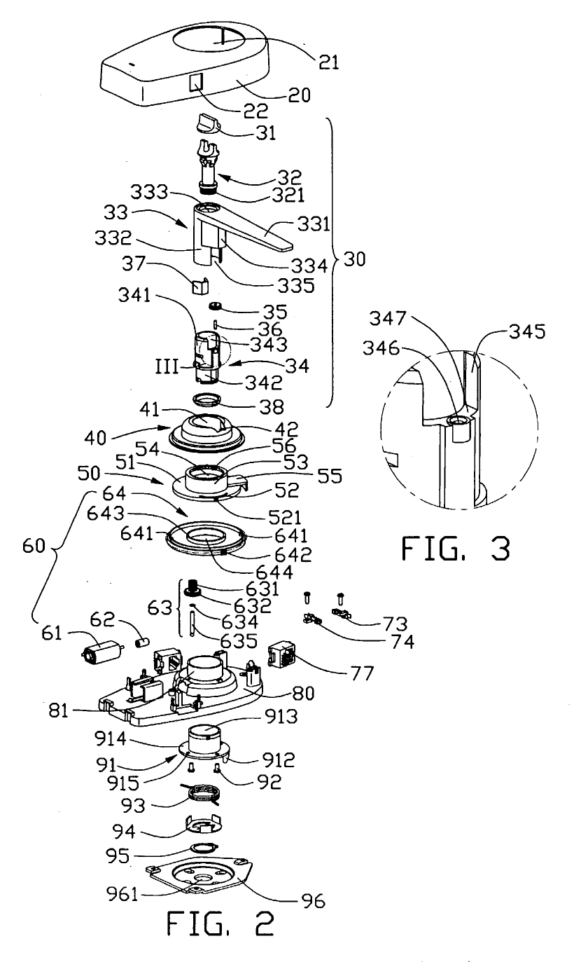

Referring to FIGS. 2 and 3, the lock unit 2 comprises a base 80, and a top cover 20 covering the base 80. The lock unit 2 further comprises a driving unit 60, a handle assembly 30, and a clutch 50 therein.

The top cover 20 defines a central hole 21 in a top wall thereof, for extension of the handle assembly 30 therethrough. A pair of connector ports 22 (only one visible) is respectively defined in opposite sidewalls of the top cover 20.

The handle assembly 30 comprises a controller shaft 32, a handle 33, a revolving sleeve 34, a pinion 35, a first gear shaft 36, a handle cover 37, and a collared ring 38.

The controller shaft 32 comprises a first annular gear portion 321 formed on a circumferential periphery of a bottom thereof. A knob 31 is attached on a top of the controller shaft 32. A cross-slot (not visible) is defined in a bottom of the controller shaft 32, for fitting extension of the transmission shaft 4 thereinto.

The handle 33 comprises a cylindrical main body 332, and a handle arm 331 extending perpendicularly from a top of the handle body 332. A through hole 333 is defined through the main body 332, for extension of the controller shaft 32 therethrough. The handle body 332 comprises a protruding portion 334 beneath the handle arm 331. A space (not labeled) within the protruding portion 334 is in communication with the through hole 333. A first cutout 335 is defined in the handle body 332 below the protruding portion 334.

Also referring to FIG. 3, the revolving sleeve 34 comprises an upper wide portion 341, and a lower slim portion 342 integrally formed with the wide portion 341. An internal diameter of the upper wide portion 341 is greater than an internal diameter of the lower slim portion 342. A through hole 343 is defined through the revolving sleeve 34. A second cutout 345 is defined in a top end of the wide portion 341, thereby forming a shoulder 347. A fixing hole 346 is defined in the shoulder 347. One end of the first gear shaft 36 is for being inserted in the pinion 35, and an opposite end of the first gear shaft 36 is for being inserted in the fixing hole 346. The pinion 35 is thus rotatably disposed on the shoulder 347.

The collared ring 38 is placed around the slim portion 342 of the revolving sleeve 34, for reinforcing the slim portion 342. The handle cover 37 is attached inside the protruding portion 334, for protecting the handle 33.

The clutch 50 comprises a base 51, and a central sleeve 53 extending upwardly from the base 51. A through hole 54 is defined through the central sleeve 53. A second annular gear portion 56 is formed on an inner face of the central sleeve 53. A pair of arcuate slits (not labeled) is defined in opposite side of the base 51 respectively, thereby forming a corresponding pair of resilient arcuate portions 52. A driven protrusion 521 is outwardly formed from a middle portion of each resilient arcuate portion 52. A sensor arm 55 extends radially outwardly from the central sleeve 53.

A cap 40 is for covering the clutch 50. A through hole 41 is defined in the cap 40, for extension of the handle 33 therethrough. A recess 42 is defined in an inner periphery of the cap 40, in communication with the through hole 41.

The drive unit 60 comprises a motor 61, a worm 62, a gear set 63, and a gear plate 64. The gear set 63 comprises an upper gear 631, a lower gear 632 integrally formed with the upper gear 631, a second gear shaft 635, and a C-shaped gasket 634. The second gear shaft 635 sequentially extends through the C-shaped gasket 634, the lower gear 632 and the upper gear 631.

The gear plate 64 is circular, and comprises a low-profile outer circumferential wall (not labeled) and a low-profile inner annular collar 643. A pair of driving protrusions 641 is inwardly formed from respective opposite sides of an inner periphery of the circumferential wall of the gear plate 64. A third annular gear portion 642 is outwardly formed from an outer periphery of the circumferential wall of the gear plate 64. A through hole 644 is defined in the collar 643. An arcuate channel (not visible) is defined in a bottom face of the gear plate 64.

The motor 61 connects with one end of the worm 62. An opposite end of the worm 62 meshes with the upper gear 631 of the gear set 63, and the lower gear 632 of the gear set 63 meshes with the third annular gear portion 642 of the gear plate 64. The driving protrusions 641 of the gear plate 64 engage with the driven protrusions 521 of the clutch 50, to actuate the clutch 50 to rotate according to rotation of the gear plate 64. The second annular gear portion 56 of the clutch 50 meshes with the pinion 35 located on the shoulder 347 of the revolving sleeve 34. The pinion 35 meshes with the first annular gear portion 321 of the controller shaft 32. When the controller shaft 32 rotates, the transmission shaft 4 rotates accordingly. The transmission shaft 4 thus actuates the latch of the bolt assembly 3 between a locked state or a unlocked state, thereby enabling the door to which the lock 1 is attached to be latched or unlatched.

Two connectors 77 and a pair of sensor switches 73, 74 are received in the lock unit 2. The sensor switches 73, 74 can contact the sensor arm 55 of the clutch 50 when the sensor arm 55 is at two different positions respectively, thereby detecting a locked or unlocked status of the lock 1.

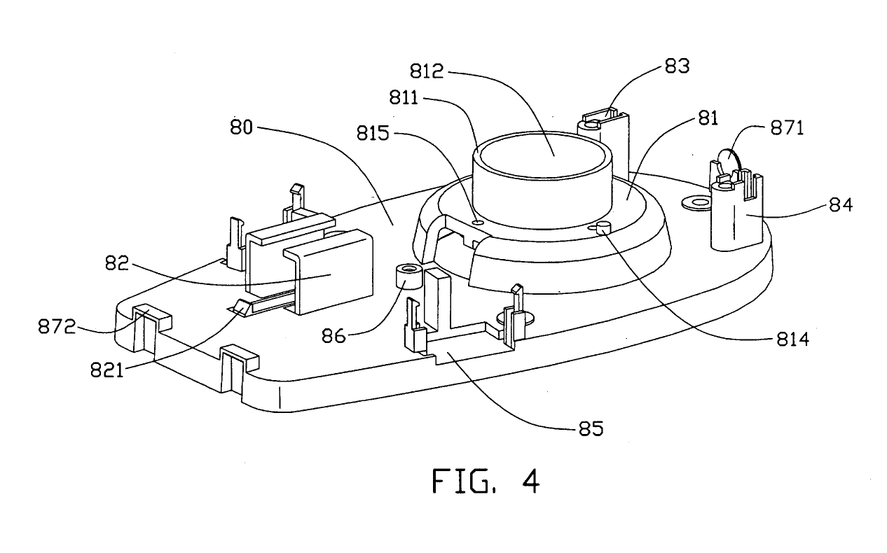

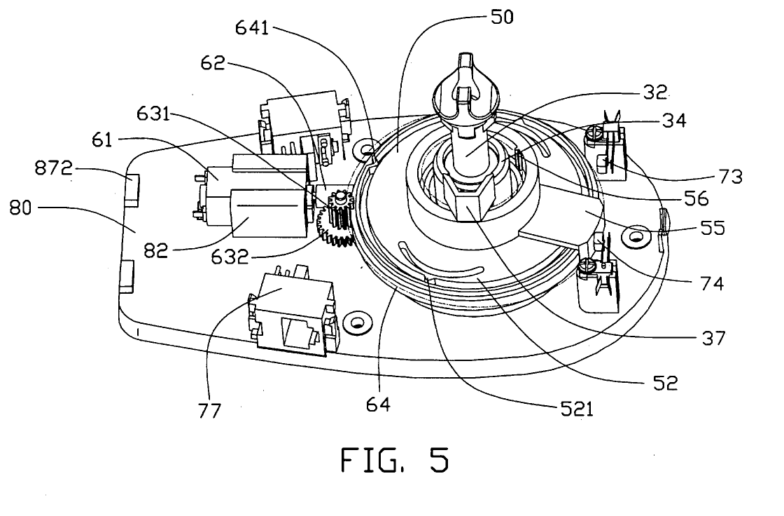

Referring also to FIG. 4, a supporting table 81 is upwardly formed from the base 80 for supporting the gear plate 64. A sleeve 811 extends upwardly from a center portion of the supporting table 81. A through hole 812 is defined in the sleeve 811. A post 814 is upwardly formed on the supporting table 81 near the sleeve 811. The post 814 is received in the arcuate channel (not visible) of the gear plate 64, to limit a range of rotation of the gear plate 64. A plurality of evenly spaced screw holes 815 (only two visible) is defined in a top surface of the supporting table 81.

A motor housing 82 is formed on the base 80 generally opposite the supporting table 81, for receiving the motor 61. A resilient clip 821 is formed in the base 80 at the motor housing 82, for locating and securing the motor 61 in the motor housing 82. A cylindrical seat 86 is upwardly formed from the base 80 generally between the supporting table 81 and the motor housing 82, for receiving the gear set 63. Two spaced switch holders 83, 84 extend upwardly from the base 80, near a periphery of the supporting table 81 that is distal from the motor housing 82. A pair of connector bracket assemblies 85 is arranged on respective opposite longitudinal sides of the base 80 at opposite sides of the motor housing 82, for respectively receiving the two connectors 77. The connectors 77 are for connecting outside electrical circuitry (not shown) with an inside of the lock unit 2.

A pair of spaced retaining tabs 872 is upwardly formed from an end of the base 80 that is near the motor housing 82. A catch 871 is upwardly formed from an opposite end of the base 80 that is near the supporting table 81.

Referring particularly to FIG. 2, the bottom cover 96 is attached to a bottom surface of the base 80. A central hole 961 is defined in the bottom cover 96, for extension of the slim portion 342 of the revolving sleeve 34 therethrough. A positioning sleeve 91 is located between the base 80 and the bottom cover 96. A coil spring 93, a limiting plate 94, and a round gasket 95 are for sequentially being placed around the slim portion 342 of the revolving sleeve 34. A through hole 913 is defined through the positioning sleeve 91, for receiving the slim portion 342 of the revolving sleeve 34. An annular flange 914 extends perpendicularly outwardly from a bottom end of the positioning sleeve 91. A pair of spaced legs 912 (only one visible) depends from a periphery of the flange 914. A plurality of evenly spaced fixing apertures 915 is defined in the flange 914. The positioning sleeve 91 is adjustably attachable in the supporting table 81, according to whether the door is to have left-hand or right-hand operation. A plurality of bolts 92 (only two visible) are for extension through the fixing apertures 915 of the flange 914 to engage in the screw holes 815 of the supporting table 81.

Referring also to FIG. 5, the following is a description of progressive stages of assembly of the lock 1.

Step 1: The worm 62 is connected to the motor 61. The motor 61 is received in the motor housing 82. The resilient clip 821 facilitates retention of the motor 61 in the motor housing 82.

Step 2: One end of the second gear shaft 635 is extended through the gear set 63 and the C-shaped gasket 634. The gear set 63 is fixed on the seat 86 of the base 80. The lower gear 632 meshes with the worm 62.

Step 3: The gear plate 64 is placed around the sleeve 811, and supported on the supporting table 81. The post 814 is received in the arcuate channel (not visible) of the gear plate 64. The clutch 50 is rotatably received in the gear plate 64. The third annular gear portion 642 meshes with the upper gear 631 of the gear set 63. The cap 40 is attached over the clutch 50.

Step 4: The connectors 77 are respectively mounted in the connector bracket assemblies 85. The sensor switches 73, 74 are respectively received in the switch holder 83, 84 of the base 80. Accordingly, the sensor arm 55 of the clutch 50 can rotate and contact each of the sensor switches 73, 74. Rotation of the sensor arm 55 is thus limited to a range between the switch holders 83, 84.

Step 5: The handle cover 37 is inserted into the protruding portion 334 of the handle 33 from an underside thereof. The pinion 35 is fixed to a top end of the first gear shaft 36, and the first gear shaft 36 is received in the fixing hole 346 of the revolving sleeve 34. Thus the pinion 35 is rotatably supported on the shoulder 347. The collared ring 38 is placed around the slim portion 342 of the revolving sleeve 34. Thus the revolving sleeve 34 is assembled as a single unit.

Step 6: the controller shaft 32 with the knob 31 fixed thereon is inserted into the through hole 333 of the handle 33 via a top end thereof. The revolving sleeve 34 with the pinion 35 thereon is insert into the through hole 333 via a bottom end thereof. The first annular gear portion 321 of the controller shaft 32 is exposed to an exterior of the revolving sleeve 34, at the first cutout 335 of the handle 33 and at the second cutout 345 of the revolving sleeve 34.

Step 7: The main body 332 of the handle 33 is extended through the through hole 41 of the cap 40, and the protruding portion 334 is fittingly received in the recess 42 of the cap 40. The pinion 35 meshes with both the first annular gear portion 321 of the controller shaft 32 and the second annular gear portion 56 of the clutch 50. The slim portion 342 of the revolving sleeve 34 is extended into the through hole 812 of the supporting table 81. The positioning sleeve 91 is attached below the base 80, with the flange 914 abutting a bottom face of the supporting table 81. The slim portion 342 is extended through the through hole 913 of the positioning sleeve 91.

Step 8: The collared ring 38 disposed around the slim portion 342 of the revolving sleeve 34 rests on a top end of the positioning sleeve 91 distal from the flange 914. The coil spring 93, the limiting plate 94, and the round gasket 95 are sequentially placed around the slim portion 342. The positioning sleeve 91 is rotated to a correct position, according to whether the door is to have left-hand or right-hand operation. The bolts 92 are extended through the fixing apertures 915 of the flange 914 to engage in the screw holes 815 of the supporting table 81. The bottom cover 96 is fixedly attached to a bottom of the base 80 using conventional fasteners.

Step 9: Finally, the base 80 and the top cover 20 are attached together. The retaining tabs 872 and the catch 871 of the base 80 engage with complementary locking mechanisms (not shown) of the top cover 20. The connector ports 22 of the top cover 20 coincide with the connectors 77 of the base 80. The cap 40 protrudes through the central hole 21 of the top cover 20. Thus, the two-part lock unit 2 is fully assembled.

Referring to FIG. 5, in operation, the motor 61 rotates the lower gear 632 via the worm 62, the upper gear 631 actuates the gear plate 64 to rotate, and the gear plate 64 rotates at a speed lower than that of the motor 61. When the gear plate 64 rotates, the driving protrusions 641 of the gear plate 64 engage with the driven protrusions 521 to actuate the clutch 50 to rotate clockwise or anti-clockwise.

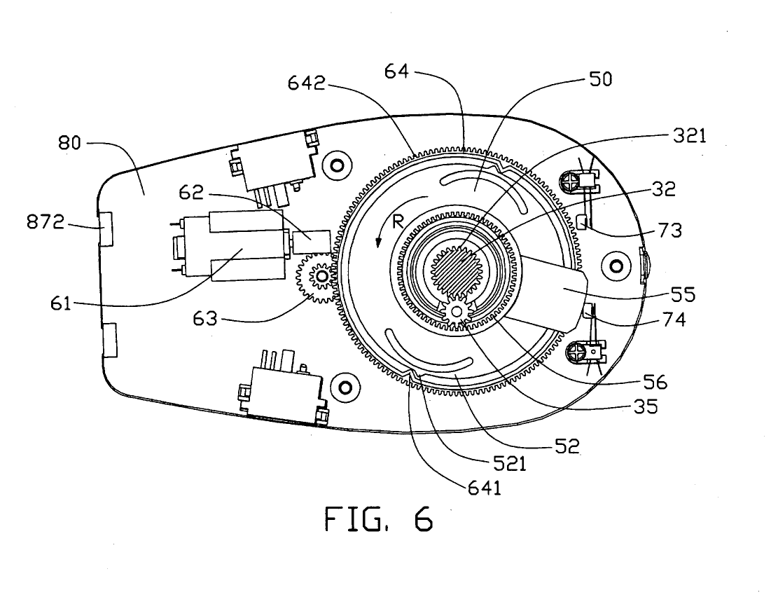

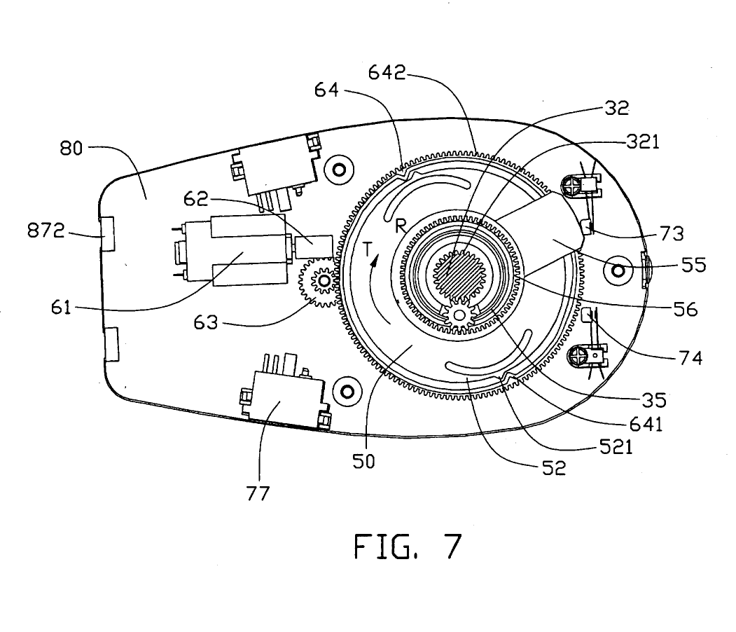

Referring to FIGS. 6 and 7, in a non-operational status, the sensor arm 55 of the clutch 50 is in contact with the sensor switch 74. When the motor 61 is turned on, the worm 62 drives the gear set 63 to rotate. The upper gear 631 of the gear set 63 rotates in a clockwise direction T. The gear plate 64 is accordingly rotated in an anti-clockwise direction R. The driving protrusions 641 of the gear plate 64 abut against the driven protrusions 521 of the resilient arcuate portions 52 at respective first side faces of the driven protrusions 521. The gear plate 64 actuates the clutch 50 to rotate in the anti-clockwise direction R. The second annular gear portion 56 of the clutch 50 meshes with the pinion 35, and the pinion 35 meshes with the first annular gear portion 321 of the controller shaft 32. Accordingly, the clutch 50 actuates the pinion 35 to rotate, the controller shaft 32 is rotated, and the transmission shaft 4 is rotated. The latch secured to the transmission shaft 4 is actuated to unlock. Simultaneously, referring to FIG. 7, the sensor arm 55 of the clutch 50 rotates to contact the sensor switch 73. The motor 61 is actuated to prepare to turn off. However, when the transmission shaft 4 reaches an unlocked position, the clutch 50 has been stopped, but the motor 61 continues to rotate due to delay control circuitry. Thus the gear plate 64 continues to rotate such that the driving protrusions 641 force the driven protrusions 521 and the resilient arcuate portions 52 to deform inwardly. The driving protrusions 641 ride over the driven protrusions 521, and the resilient arcuate portions 52 resiliently return to their original orientations. Finally, the gear plate 64 stops when the motor 61 is turned off by the delay control circuitry.

When the gear plate 64 rotates in the clockwise direction T, the driving protrusions 641 abut against the driven protrusions 521 at respective second side faces of the driven protrusions 521. The gear plate 64 actuates the clutch 50 to rotate in the clockwise direction T. Accordingly, the clutch 50 actuates the pinion 35 to rotate, the controller shaft 32 is rotated, and the transmission shaft 4 is rotated. The latch secured to the transmission shaft 4 is actuated to lock. Simultaneously, the sensor arm 55 rotates to contact the sensor switch 74. The motor 61 is actuated to prepare to turn off. However, when the transmission shaft 4 reaches a locked position, the clutch 50 has been stopped, but the motor 61 continues to rotate due to delay control circuitry. Thus the gear plate 64 continues to rotate such that the driving protrusions 641 force the driven protrusions 521 and the resilient arcuate portions 52 to deform inwardly. The driving protrusions 641 ride over the driven protrusions 521, and the resilient arcuate portions 52 resiliently return to their original orientations. Finally, the gear plate 64 stops when the motor 61 is turned off by the delay control circuitry.

A user can operate the lock 1 by hand, without employing the driving unit 60. The user may want to do so if, for example, the driving device 60 has failed after the lock I has been locked. The user turns the knob 31 attached on a top of the controller shaft 32, to rotate the transmission shaft 4. Referring to FIG. 6, the user turns the knob 31 in the anti-clockwise direction R to operate the lock 1. As described above in relation to locking of the lock 1, the driving protrusions 641 of the gear plate 64 have already ridden over the driven protrusions 541 of the clutch 50. Therefore, the clutch 50 is free to move in direction R. Accordingly, the controller shaft 32 can freely rotate in direction R. The motor 61 cannot be “back driven” by the user turning the handle 33 in direction R.

It is understood that the invention may be embodied in other forms without departing from the spirit thereof. Thus, the present example and embodiment is to be considered in all respects as illustrative and not restrictive, and the invention is not to be limited to the details given herein.

1. An electronically operated lock comprising:
a bolt assembly having a latch;
a transmission shaft extending through the bolt assembly; and
a lock unit comprising a base, a cover covering the base, a handle assembly, a driving unit, and a clutch; the handle assembly comprising a controller shaft having a first gear portion, the controller shaft receiving the transmission shaft therein; the driving unit comprising a gear plate having a pair of driving protrusions; the clutch comprising a pair of driven protrusions, the clutch being rotatably received in the gear plate,
wherein when the driven protrusions of the clutch are actuated by the driving protrusions of the gear plate, the clutch actuates the handle assembly to rotate the transmission shaft, thereby actuating the latch between a locked state and an unlocked state.

2. The electronically operated lock as claimed in claim 1, wherein the handle assembly comprises a pinion meshing with the first gear portion.

3. The electronically operated lock as claimed in claim 2, wherein a central sleeve extends upwardly from a base of the clutch, a through hole is defined in the central sleeve, a second gear portion is formed on an inner face of the central sleeve at the through hole, and the second gear portion meshes with the pinion.

4. The electronically operated lock as claimed in claim 3, wherein a pair of arcuate slits is defined in opposite sides of the base thereby forming a pair of resilient arcuate portions, and the driven protrusions are outwardly formed from the resilient arcuate portions.

5. The electronically operated lock as claimed in claim 3, wherein the gear plate comprises a third gear portion around an outer circumference thereof.

6. The electronically operated lock as claimed in claim 1, wherein the driving protrusions of the gear plate are inwardly formed from respective opposite sides of an inner periphery of a circumferential wall of the gear plate.

7. The electronically operated lock as claimed in claim 5, wherein the drive unit further comprises a motor, a worm connecting with the motor, and a gear set.

8. The electronically operated lock as claimed in claim 7, wherein the gear set comprises an upper gear meshing with the third gear portion, a lower gear integrally formed with the upper gear and meshes with the worm, a second gear shaft, and a C-shaped gasket.

9. The electronically operated lock as claimed in claim 2, wherein the handle assembly further comprises a handle, the handle comprises a main body and a lever arm, a first cutout is defined in the main body, and the main body receives the controller shaft therein.

10. The electronically operated lock as claimed in claim 9, wherein the handle assembly further comprises a revolving sleeve and a first gear shaft, the revolving sleeve comprises an upper wide portion and a lower slim portion, a second cutout is defined in a top of the wide portion thereby forming a shoulder rotatably supporting the pinion thereon, a fixing hole is defined in the shoulder receiving one end of the first gear shaft, and an opposite end of the first gear shaft is received in the pinion.

11. The electronically operated lock as claimed in claim 1, wherein the lock unit further comprises a cap covering the clutch, a through hole is defined in the cap, and a recess is defined in the cap in communication with the through hole.

12. The electronically operated lock as claimed in claim 10, wherein a supporting table is arranged on the base of the lock unit, a sleeve is arranged on the supporting table, and the gear plate surrounds the sleeve of the supporting table and the clutch.

13. The electronically operated lock as claimed in claim 12, wherein a positioning sleeve, a spring, a limiting plate, a round gasket and a bottom cover are sequentially disposed around the slim portion of the revolving sleeve, and the slim portion of the revolving sleeve extends through the clutch and the sleeve of the supporting table.

14. The electronically operated lock as claimed in claim 1, wherein a pair of sensor switches is received in a pair of switch holders arranged on the base, the clutch has a sensor arm movable between the sensor switches, and the sensor arm can contact either one of the sensor switches for detecting the locked or unlocked state of the lock.

15. The electronically operated lock as claimed in claim 11, wherein the motor is received in a motor housing arranged on the base, and a resilient clip is formed at the motor housing for facilitating retention of the motor.

16. The electronically operated lock as claimed in claim 1, wherein a pair of connector bracket assemblies is arranged on the base for receiving a pair of connectors therein respectively.

17. An electronically driven lock comprising:
a bolt assembly having a latch therein;
a transmission shaft extending through the bolt assembly for actuating the latch;
a lock unit comprising a base, a top cover attached on the base, a handle assembly, a clutch and a driving unit; the handle assembly comprising a pinion and a controller shaft, the controller shaft comprising a first gear portion, the controller shaft receiving the transmission shaft therein; the clutch comprising a sleeve and a second gear portion arranged at the sleeve, the driving unit comprising a gear plate, the gear plate comprising a third gear portion arranged at a circumferential wall thereof; the clutch being received in the gear plate and actuatable thereby; the second gear portion of the clutch meshing with the pinion of the handle assembly, and the pinion of the handle assembly meshing with the first gear portion of the controller shaft.

18. The electronically driven lock as claimed in claim 17, wherein the driving unit further comprises a motor, a worm, and a gear set, and the gear plate actuated by the gear set.

19. The electronically driven lock as claimed in claim 17, wherein the clutch further comprises a base supporting the sleeve, and the second gear portion is arranged on an inner face of the sleeve.

20. The electronically driven lock as claimed in claim 19, wherein a pair of arcuate slits is defined in opposite sides of the base of the clutch thereby forming a pair of resilient portions, and a pair of driven protrusions is arranged at the resilient portions.

21. The electronically driven lock as claimed in claim 20, wherein a pair of driving protrusions is arranged at opposite sides of an inner circumferential wall of the gear plate, and an arcuate channel is defined in a bottom of the gear plate; and when the lock is operated between a locked state and an unlocked state, the driving protrusions drive the driven protrusions and then ride over the driven protrusions.

22. An electrically operated lock equipped with manual operation mechanism, comprising:
a stationary base;
a transmission shaft rotatable relative to the base and extending in a first direction, said transmission shaft being adapted to be rotated to two positions deciding whether a lock bolt is allowed to move along a second direction perpendicular to said first direction;
an inner lock unit actuating the transmission shaft to rotate clockwise or counterclockwise, said inner lock unit including:
a driving unit having a gear plate actuated by a motor, said gear plate defining a driving protrusion thereon; and
a clutch unit connected, via a pinion, to a mating shaft linked to said transmission shaft, said clutch unit defining a driven protrusion engaged with said driving protrusion; wherein
said driving unit and said clutch unit are concentrically rotated relative to the base.

23. The lock as described in claim 22, wherein said driving unit and said clutch unit are essentially synchronically rotated, either clockwise or counterclockwise, with each other, when the driving unit is actuated to rotate by the motor and urges the clutch unit to rotate too, while only the clutch unit is rotated during manual operation.

24. The lock as described in claim 22, wherein said at least one of said driving unit and said clutch unit own resiliency, so as to allow said driving protrusion to be mutually exclusively located on respectively opposite sides of said driven protrusion, when said driving unit is actuated to rotate by the motor either clockwise or counterclockwise.

25. The lock as described in claim 22, wherein said gear plate defines outer gears adapted to be directly or indirectly actuated by the motor.

26. The lock as described in claim 22, wherein said pinion is rotatable about its own center axis for transfer movement from the clutch to the mating shaft.

27. The lock as described in claim 26, wherein said axis of the pinion is fixed to a revolving sleeve which is rotatable about the mating shaft which is stationary during rotation of the clutch unit.
